(19) United States
(12) Patent Application Publication
(10) Pub. No.: US 2025/0293289 A1
(43) Pub. Date: Sep. 18, 2025

(54) ALL-SOLID-STATE BATTERY

(71) Applicant: SAMSUNG ELECTRO-MECHANICS CO., LTD., Suwon-si, Gyeonggi-do (KR)

(72) Inventor: Jieun Wang, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/702,624

(22) PCT Filed: Mar. 25, 2024
(86) PCT No.: PCT/KR2024/003674

§ 371 Date: Apr. 18, 2024

(30) Foreign Application Priority Data
Oct. 13, 2023 (KR) 10-2023-0137103

(51) Int. Cl. H01M 10/0525; H01M 4/02; H01M 4/131; H01M 4/525; H01M 10/0562

(52) U.S. Cl. CPC H01M 10/0525; H01M 4/131; H01M 4/525; H01M 10/0562; H01M 2004/028; H01M 2300/0071

(57) ABSTRACT

An embodiment provides an all-solid-state battery including a solid electrolyte layer, and a positive electrode layer and a negative electrode layer disposed with the solid electrolyte layer interposed therebetween, wherein the solid electrolyte layer includes a first solid electrolyte, the positive electrode layer or the negative electrode layer includes an electrode active material and a second solid electrolyte surrounding a part of the surface of the electrode active material with an average thickness of 1 nm to 10 nm, the electrode active material includes a positive electrode active material, the positive electrode active material includes a high cobalt-based positive electrode active material represented by chemical formula 1: LiCoₓM¹_{y}M²_{1-x-y}O₂.

### TECHNICAL FIELD

The present disclosure relates to an all-solid-state battery.

### BACKGROUND ART

Recently, as portable electronic devices are required to be miniaturized and used for long periods of time, higher capacity batteries are required, and with the spread of wearable electronic devices, there is a demand to ensure the safety of batteries. Therefore, the development of all-solid-state batteries using solid electrolytes instead of liquid electrolytes is actively underway.

All-solid-state batteries do not use flammable organic solvents, so additional circuits for safety can be simplified. Therefore, it is expected to be a technology that can manufacture safe batteries with high capacity per unit volume.

In addition, oxide all-solid-state batteries using oxide electrolytes have lower ionic conductivity of the electrolyte (10⁻⁴ S/cm to 10⁻⁶ S/cm) than sulfide (10⁻² S/cm), and require a high-temperature firing process. However, its stability is superior to that of sulfide all-solid-state batteries that use a sulfide electrolyte that reacts with oxygen and moisture in the air.

The stacked oxide all-solid-state battery is an ultra-small battery, which can be mounted on a substrate like a passive device, and is stable even when exposed to high temperatures during the reflow process.

In the positive electrode layer included in the stacked oxide all-solid-state battery, it is difficult to co-sinter because it contains a positive electrode active material and a conductive agent that do not sinter, and it is difficult to uniformly form an interface bonding between materials.

To improve this, a sintering agent is added to the positive electrode layer to assist simultaneous sintering to improve the interfacial bonding of the positive electrode layer. However, if the ionic conductivity of the sintering aid is low, it cannot contribute to the improvement of the ionic conductivity of the positive electrode layer, resulting in a decrease in the rate capability of the cell.

### SUMMARY

### Technical Problem

One aspect of the embodiments provides an all-solid-state battery capable of improving the rate capability of the battery by densifying the electrode layer while improving interfacial bonding between materials.

However, embodiments of the present disclosure are not limited to those mentioned above, and may be variously extended in the scope of the technical ideas included in the present disclosure.

### Solution to Problem

An all-solid-state battery according to some embodiments includes a solid electrolyte layer; and a positive electrode layer and a negative electrode layer disposed with the solid electrolyte layer interposed therebetween, wherein the solid electrolyte layer includes a first solid electrolyte,
the positive electrode layer or the negative electrode layer includes an electrode active material and a second solid electrolyte surrounding a part of the surface of the electrode active material with an average thickness of 1 nm to 10 nm,
the electrode active material includes a positive electrode active material,
the positive electrode active material includes a high cobalt-based positive electrode active material represented by Chemical Formula 1.

LiCoₓM¹_{y}M²_{1-x-y}O₂ [Chemical Formula 1]
in Chemical Formula 1, 0.6≤x≤1.0, 0≤y≤0.3,
M¹ is Ni, Al, Mn, or a combination thereof, and M² is Mn, Na, Mg, Ti, Ni, Al, Si, Zr, Zn, Nb, Cr, Fe, Sr, V, Cu, B, Ba, Ca, Ce, Se, Sn, W, Y, or a combination thereof.

A lithium ion conductivity (25° C.) of the second solid electrolyte may be 1.0×10² times or more than a lithium ion conductivity (25° C.) of the first solid electrolyte.

The lithium ion conductivity (25° C.) of the first solid electrolyte may be 1.0×10⁻⁷ S/cm to 1.0×10⁻⁶ S/cm.

The lithium ion conductivity (25° C.) of the second solid electrolyte may be 1.0×10⁻⁴ S/cm to 1.0×10⁻³ S/cm.

The first solid electrolyte may include a glass-ceramic-based electrolyte including at least one selected from the group consisting of lithium (Li) oxide, boron (B) oxide, silicon (Si) oxide, phosphorus (P) oxide, germanium (Ge) oxide, and lithium chloride (LiCl), or a lithium borosilicate-based electrolyte including lithium (Li) oxide, silicon (Si) oxide, and boron (B) oxide.

The second solid electrolyte may include at least one selected from the group consisting of a Garnet-type solid electrolyte, a Nasicon-type solid electrolyte, a LISICON-type solid electrolyte, and combinations thereof.

The Garnet-type solid electrolyte may include a lithium lanthanum zirconium oxide.

The Nasicon-type solid electrolyte may include lithium-aluminum-titanium-phosphate represented by Li₁₊ₓAlₓTi₂₋ₓ(PO₄)₃ (0<x<1), or lithium-aluminum-germanium-phosphate represented by Li₁₊ₓAlₓGe₂₋ₓ(PO₄)₃ (0<x<1).

The second solid electrolyte may be included in an amount of 0.1 to 10 parts by weight based on 100 parts by weight of the electrode active material.

The second solid electrolyte may surround 5% or more of the surface area of the electrode active material.

The positive electrode layer or the negative electrode layer may further include the first solid electrolyte.

An all-solid-state battery according to another embodiment includes a solid electrolyte layer, and a positive electrode layer and a negative electrode layer disposed with the solid electrolyte layer interposed therebetween, wherein the solid electrolyte layer includes a first solid electrolyte,
the positive electrode layer or the negative electrode layer includes an electrode active material and a second solid electrolyte surrounding a part of the surface of the electrode active material with an average thickness of 1 nm to 10 nm,
a lithium ion conductivity (25° C.) of the second solid electrolyte is 1.0×10² times or more than a lithium ion conductivity (25° C.) of the first solid electrolyte,
the electrode active material includes a positive electrode active material,
the positive electrode active material includes a high cobalt-based positive electrode active material represented by Chemical Formula 1.

LiCoₓM¹_{y}M²_{1-x-y}O₂ [Chemical Formula 1]

in Chemical Formula 1, 0.6≤x≤1.0, 0≤y≤0.3,

M¹ is Ni, Al, Mn, or a combination thereof, and M² is Mn, Na, Mg, Ti, Ni, Al, Si, Zr, Zn, Nb, Cr, Fe, Sr, V, Cu, B, Ba, Ca, Ce, Se, Sn, W, Y, or a combination thereof.

The lithium ion conductivity (25° C.) of the first solid electrolyte may be 1.0×10⁻⁷ S/cm to 1.0×10⁻⁶ S/cm.

The lithium ion conductivity (25° C.) of the second solid electrolyte may be 1.0×10⁻⁴ S/cm to 1.0×10⁻³ S/cm.

The first solid electrolyte may include at least one selected from the group consisting of a glass-ceramic-based electrolyte including lithium (Li) oxide, boron (B) oxide, silicon (Si) oxide, phosphorus (P) oxide, germanium (Ge) oxide, and lithium chloride (LiCl), or a lithium borosilicate-based electrolyte including lithium (Li) oxide, silicon (Si) oxide, and boron (B) oxide.

The second solid electrolyte may include a Garnet-type solid electrolyte, a Nasicon-type solid electrolyte, a LISICON-type solid electrolyte, or a combination thereof.

The Garnet-type solid electrolyte may include a lithium lanthanum zirconium oxide.

The Nasicon-type solid electrolyte may include lithium-aluminum-titanium-phosphate represented by Li₁₊ₓAlₓTi₂₋ₓ(PO₄)₃ (0<x<1), or lithium-aluminum-germanium-phosphate represented by Li₁₊ₓAlₓGe₂₋ₓ(PO₄)₃ (0<x<1).

The second solid electrolyte may be included in an amount of 0.1 to 10 parts by weight based on 100 parts by weight of the electrode active material.

The second solid electrolyte may surround 5% or more of the surface area of the electrode active material.

The positive electrode layer or the negative electrode layer may further include the first solid electrolyte.

### Advantageous Effects

The all-solid-state battery according to an embodiment has the advantage of improving the rate capability of the battery by densifying the electrode layer while improving interfacial bonding between materials.

The above and other aspects, features, and advantages of the present disclosure will be more clearly understood from the following detailed description taken in conjunction with the accompanying drawings.

### BRIEF DESCRIPTION OF DRAWINGS

FIG. 1 is a perspective view schematically illustrating an all-solid-state battery according to an embodiment.

FIG. 2 is a cross-sectional view of an all-solid-state battery according to an embodiment.

FIG. 3 is a cross-sectional view schematically illustrating a positive electrode layer of an all-solid-state battery according to an embodiment.

### DETAILED DESCRIPTION OF THE EMBODIMENTS

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. The accompanying drawings are intended only to facilitate an understanding of the exemplary embodiments disclosed in this specification, and it is to be understood that the technical ideas disclosed herein are not limited by the accompanying drawings and include all modifications, equivalents, or substitutions that are within the range of the ideas and technology of the present disclosure. In the accompanying drawings, some constituent elements are exaggerated, omitted, or schematically illustrated, and the size of each constituent element does not entirely reflect the actual size.

In addition, unless explicitly described to the contrary, the word “comprise”, and variations such as “comprises” or “comprising”, will be understood to imply the inclusion of stated elements but not the exclusion of any other elements.

Throughout the specification, the “stacking direction” refers to the direction in which the constituent elements are sequentially stacked, and may also be the “thickness direction” perpendicular to the wide surface (main surface) of the constituent elements on the sheet, which corresponds to the T-axis direction. Also, the “side” refers to the direction extending parallel to the wide surface (main surface) from the edge of the constituent element on the sheet, which may be a “plane direction”, and corresponds to the L-axis direction in the drawing. In addition, the W-axis direction in the drawing may be the “width direction”.

Hereinafter, various exemplary embodiments and variations will be described in detail with reference to the drawings.

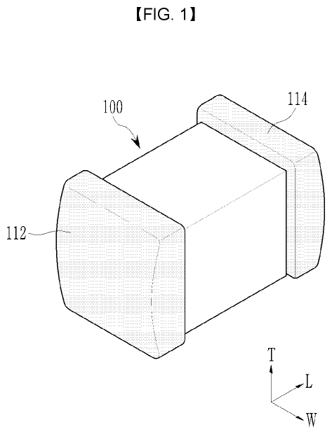

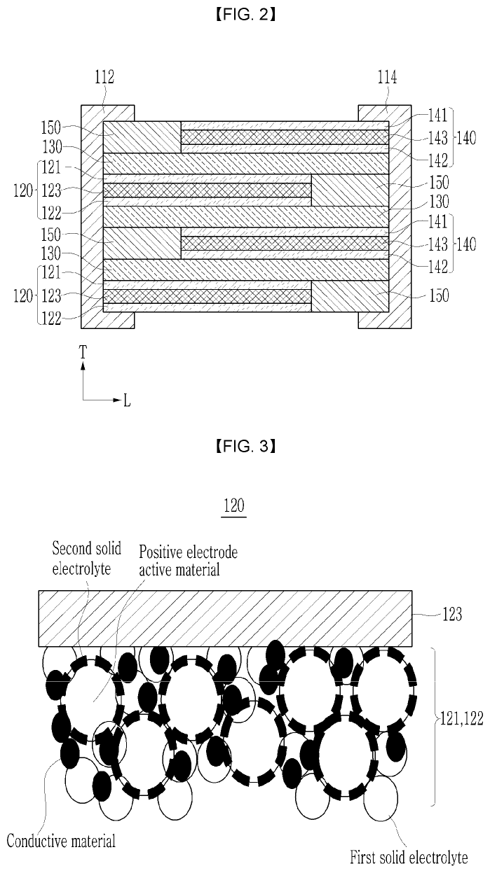

FIG. 1 is a perspective view schematically illustrating an all-solid-state battery according to some embodiments of the present disclosure, and FIG. 2 is a cross-sectional view of an all-solid-state battery according to some embodiments of the present disclosure.

For example, an all-solid-state battery 100 may have a roughly hexahedral shape.

In this embodiment, for convenience of description, the two surfaces facing each other in the thickness direction (T-axis direction) of the all-solid-state battery 100 are defined as a first surface and a second surface, and the two surfaces connected to the first surface and the second surface and facing each other in the length direction (L-axis direction) are defined as a third surface and a fourth surface. For example, the first and second surfaces of the all-solid-state battery 100 facing each other may be the third and fourth surfaces.

The all-solid-state battery 100 according to some embodiments includes a solid electrolyte layer 130; and a cell stack including a positive electrode layer 120 and a negative electrode layer 140 disposed with the solid electrolyte layer 130 interposed therebetween.

The solid electrolyte layer 130 includes a first solid electrolyte, and the positive electrode layer 120 or the negative electrode layer 140 includes an electrode active material and a second solid electrolyte located on the surface of the electrode active material.

The solid electrolyte layer 130 may be stacked between the positive electrode layer 120 and the negative electrode layer 140. Accordingly, the solid electrolyte layer 130 may be disposed adjacent to positive electrode active material layers 121 and 122 of the positive electrode layer 120 and negative electrode active material layers 141 and 142 of the negative electrode layer 140 in the stacking direction.

Accordingly, in the all-solid-state battery 100, a plurality of positive electrode layers 120 and negative electrode layers 140 may be alternately arranged and stacked with a plurality of solid electrolyte layers 130 interposed therebetween. The all-solid-state battery 100 may be a stacked all-solid-state battery 100 manufactured by alternately stacking the plurality of positive electrode layers 120 and negative electrode layers 140, interposing the plurality of solid electrolyte layers 130 therebetween, and then batch firing them.

The solid electrolyte layer 130 includes a first solid electrolyte.

The lithium ion conductivity of the first solid electrolyte (25° C.) is at least 1.0×10² times lower than that of the second solid electrolyte.

For example, the lithium ion conductivity of the first solid electrolyte may be 1.0×10⁻⁷ S/cm to 1.0×10⁻⁶ S/cm. Lithium ion conductivity may be a value measured at a temperature of 25° C.

The lithium ion conductivity of the first solid electrolyte may be measured by the alternating current (AC) impedance method.

For example, first, a part of the solid electrolyte layer 130 in the all-solid-state battery 100 is sampled as a rectangular plate-shaped piece by ion milling or polishing. Next, electrodes made of gold (Au) are formed on both ends of the obtained piece to prepare a sample. Next, the ionic conductivity is calculated by measuring AC impedance (frequency: 10⁺⁶ Hz to 10⁻¹ Hz, voltage: 10 mV, 100 mV) on the sample at room temperature (25° C.) using an impedance measurement device.

According to some embodiments, a pellet made of the first solid electrolyte may be manufactured, and after sintering the pellet at 470° C. to 550° C., an electrode made of gold (Au) may be formed on both ends of the pellet to produce a sample. The ion conductivity may be calculated in the same method as described above.

For example, the first solid electrolyte may be an oxide-based solid electrolyte, and the oxide-based solid electrolyte may include a glass-ceramic-based electrolyte or a lithium borosilicate (LBSO)-based electrolyte.

Glass-ceramic (or crystallized glass) refers to a mixture of amorphous and crystalline crystallographic elements, such as peaks and halos observed in X-ray diffraction or electron beam diffraction.

Therefore, the glass-ceramic electrolyte is an electrolyte in which amorphous and crystalline are mixed, as some crystallization has occurred through firing.

When the glass-ceramic-based electrolyte is included, it is possible to implement high ionic conductivity after sufficient densification is achieved through firing.

The glass-ceramic-based electrolyte may include at least one selected from the group consisting of lithium (Li) oxide, boron (B) oxide, silicon (Si) oxide, phosphorus (P) oxide, germanium (Ge) oxide, and lithium chloride (LiCl).

According to some embodiments, the glass-ceramic electrolyte may include Li₂O—B₂O₃—SiO₂—P₂O₅—GeO₂—LiCl. For example, the glass-ceramic-based electrolyte may include a lithium chloroboracite crystal phase.

The lithium borosilicate-based electrolyte (hereinafter referred to as “LBSO-based electrolyte”) is an electrolyte in the glass state, wherein the glass is crystallographically amorphous, such that halos are observed in X-ray diffraction, electron diffraction, and the like.

When the lithium borosilicate-based electrolyte is included, it is possible to reduce the firing temperature while maintaining the amorphous state during firing, thereby realizing high ion conductivity and low reactivity with an electrode. The lithium borosilicate-based electrolyte may include lithium (Li) oxide, silicon (Si) oxide, and boron (B) oxide, and for example, may include Li₂O—SiO₂—B₂O₃.

Optionally, the lithium borosilicate-based electrolyte may further include at least one selected from the group consisting of Na (sodium), Mg (magnesium), Al (aluminum), P (phosphorus), K (potassium), Ca (calcium), Ti (titanium), V (vanadium), Cr (chromium), Mn (manganese), Fe (iron), Co (cobalt), Ni (nickel), Cu (copper), Zn (zinc), Ga (gallium), Ge (germanium), Se (selenium), Rb (rubidium), S (sulfur), Y (yttrium), Zr (zirconium), Nb (niobium), Mo (molybdenum), Ag (silver), In (indium), Sn (tin), Sb (antimony), Cs (cesium), Ba (vanadium), Hf (hafnium), Ta (tantalum), W (tungsten), Pb (lead), Bi (bismuth), Au (gold), La (lanthanum), Nd (neodymium), Eu (europium) and additional oxides including combinations thereof.

The solid electrolyte layer 130 may further comprise an inorganic solid electrolyte other than the first solid electrolyte described above, including an oxide-based solid electrolyte, a sulfide-based solid electrolyte, or a combination thereof.

Other oxide-based solid electrolytes may be Garnet-type, Nasicon-type, LISICON-type, perovskite-type, LiPON-type, or amorphous (glass) electrolyte, and the like.

The Garnet-type solid electrolytes may indicate lithium-lanthanum zirconium oxide (LLZO) represented by LiₐLa_{b}Zr_{c}O₁₂, such as Li₇La₃Zr₂O₁₂. The Nasicon-type solid electrolyte may indicate lithium-aluminum-titanium-phosphate (LATP) represented by Li₁₊ₓAlₓTi₂₋ₓ(PO₄)₃(0<x<1) in which Ti is introduced into a Li₁₊ₓAlₓM₂₋ₓ(PO₄)₃ (LAMP) (0<x<2, wherein M is Zr, Ti, or Ge)-type compound, lithium-aluminum-germanium-phosphate (LAGP) represented by Li₁₊ₓAlₓGe₂₋ₓ (PO₄)₃(0<x<1), such as Li_{1.3}Al_{0.3}Ti_{1.7}(PO₄)₃ or the like in which excess lithium is introduced, and/or lithium-zirconium-phosphate (LZP) of LiZr₂(PO₄)₃.

In addition, the LISICON-type solid electrolyte may indicate a solid solution oxide represented by xLi₃AO₄-(1-x)Li₄BO₄ (A: P, As, V, etc., B: Si, Ge, Ti, etc., 0<x<1) and including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, etc., and solid solution sulfide including Li₂S—P₂S₅, Li₂S—SiS₂, Li₂S—SiS₂—P₂S₅, or Li₂S—GeS₂, etc. represented by Li₄₋ₓM_{1-y}M′_{y}S₄ (M: Si, Ge, and M′: P, Al, Zn, or Ga).

The perovskite-type solid electrolyte may indicate lithium-lanthanum-titanium-oxide (LLTO) represented by Li₃ₓLa_{2/3-x□1/3-2x}TiO₃ (0<x<0.16, □: vacancy), such as Li_{1/8}La_{5/8}TiO₃ or the like, and the LiPON-type solid electrolyte may refer to a nitride such as lithium-phosphorous-oxynitride, such as Li_{2.8}PO_{3.3}N_{0.46} or the like.

The amorphous electrolyte may include Li₂O—B₂O₃—SiO₂, Li₂O—B₂O₃—P₂O₅, Li₃BO₃—Li₂CO₃, or Li₃BO₃—Li₂CO₃, or the like.

The sulfide-based solid electrolyte includes sulfur atoms among the electrolyte components and is not particularly limited to specific components, and may include one or more of a crystalline solid electrolyte, an amorphous solid electrolyte (glassy solid electrolyte), or a glass ceramic solid electrolyte.

For example, the sulfide-based solid electrolyte may include LPS-type sulfides including sulfur and phosphorus (for example, Li₂S—P₂S₅), and Thio-LISICON type compounds, such as Li₄₋ₓGe₁₋ₓPₓS₄ (where x may be 0.1 to 2, ¾, or ⅔), Li_{10±1}MP₂X₁₂ (where M is Ge, Si, Sn, or Al, and X is S or Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-(100-x)P₂S₅ (where x is 70 to 80), Li₂S—SiS₂—Li₃N, Li₂S—P₂S₅—LiI, Li₂S—SiS₂—LiI, Li₂S—B₂S₃—LiI, Li₁₀SnP₂S₁₂, and Li_{3.25}Ge_{0.25}P_{0.75}S₄.

The electrode layer includes the positive electrode layer 120 and the negative electrode layer 140, and may basically include current collectors 123 and 143 and electrode active material layers 121, 122, 141 and 142 applied to at least one surface of the current collectors 123 and 143.

Referring to FIG. 2, the positive electrode layer 120 may be formed by applying the positive electrode active material layers 121 and 122 to at least one surface of the positive electrode current collector 123, and the negative electrode layer 140 may be formed by applying the negative electrode active material layers 141 and 142 to at least one surface of the negative electrode current collector 143.

For example, the electrode layer located at the bottom based on the stacking direction may be formed by applying the positive electrode active material layer 122 to one surface of the positive electrode current collector 123, and the electrode layer located at the top may be formed by applying the negative electrode active material layer 141 to one surface of the negative electrode current collector 143.

Further, the electrode layers located between the top and bottom may be formed by applying the positive electrode active material layers 121 and 122 on both surfaces of the positive electrode current collector 123, or by applying the negative electrode active material layers 141 and 142 on both surfaces of the negative electrode current collector 143.

In the all-solid-state battery 100 according to some embodiments, the positive electrode layer 120 includes a positive electrode active material and a second solid electrolyte located on the surface of the positive electrode active material, and/or the negative electrode layer 140 includes a negative electrode active material and a second solid electrolyte located on the surface of the negative electrode active material.

Hereinafter, the positive electrode active material and the second solid electrolyte located on the surface of the positive electrode active material will be mainly described in detail. The description regarding the positive electrode active material and the second solid electrolyte located on the surface of the positive electrode active material may also be applied to the negative electrode active material and the second solid electrolyte located on the surface of the negative electrode active material.

FIG. 3 is a cross-sectional view schematically illustrating the positive electrode layer 120 of an all-solid-state battery according to some embodiments.

Referring to FIG. 3, the positive electrode active material layers 121 and 122 include a positive electrode active material and a second solid electrolyte located on the surface of the electrode active material.

Additionally, the positive electrode active material layers 121 and 122 may optionally further include additives such as a solid electrolyte, a binder, or a conductive material.

The second solid electrolyte has a lithium ion conductivity (25° C.) of 1.0×10² times higher than that of the above-described first solid electrolyte.

For example, the lithium ion conductivity of the second solid electrolyte may be 1.0×10⁻⁴ S/cm to 1.0×10⁻³ S/cm. Lithium ion conductivity may be a value measured at a temperature of 25° C.

The lithium ion conductivity of the second solid electrolyte may be measured by the AC impedance method.

For example, first, a part of the second solid electrolyte included in the positive electrode active material layers 121 and 122 is sampled into a rectangular plate-shaped piece by ion milling or polishing. At this time, the sample may include only of the second solid electrolyte. Next, electrodes made of gold (Au) are formed on both ends of the obtained piece to prepare a sample. Next, the ionic conductivity is calculated by measuring AC impedance (frequency: 10⁺⁶ Hz to 10⁻¹ Hz, voltage: 10 mV, 100 mV) on the sample at room temperature (25° C.) using an impedance measurement device.

As another example, the ionic conductivity may be measured by molding the powder of the second solid electrolyte into a pellet type and then sintering the power of the second solid electrolyte. Specifically, the powder of the second solid electrolyte is put into a pellet mold with a diameter of about 14 mm, pressed to 0.5 tons to produce a pellet molded body, and then sintered to produce a second solid electrolyte sintered body. A sample is manufactured by polishing both sides of the sintered body smoothly and then forming electrodes made of gold (Au). Next, the ionic conductivity is calculated by measuring AC impedance (frequency: 10⁺⁶ Hz to 10⁻¹ Hz, voltage: 10 mV, 100 mV) on the sample at room temperature (25° C.) using an impedance measurement device.

The second solid electrolyte is a solid electrolyte with superior ionic conductivity than the first solid electrolyte, and does not lower the ionic conductivity of the electrode layer and does not prevent densification of the electrode layer, thereby improving the rate capability of the all-solid-state battery.

Additionally, the second solid electrolyte may serve as a bridge between the electrode active material included in the electrode layer and the first solid electrolyte included in the solid electrolyte layer, thereby improving interfacial bonding between the electrode active material layer and the solid electrolyte layer.

In addition, although the second solid electrolyte has superior ionic conductivity than the first solid electrolyte, the sintering temperature may be relatively higher or the possibility of side reactions occurring may be higher than that of the first solid electrolyte. Therefore, the second solid electrolyte may not be suitable for inclusion in the solid electrolyte layer, but may be suitable for placement on the surface of the electrode active material in the electrode layer.

The side reaction may refer to the case where the solid electrolyte undergoes an oxidation/reduction reaction and decomposes in a specific voltage range within the all-solid-state battery driving voltage, the case where the materials of the solid electrolyte and electrode layer (positive electrode material, negative electrode material, or conductive material, etc.) during the all-solid-state battery manufacturing process, and the case where the solid electrolyte layer and the electrode layer cause a reaction other than charge/discharge reaction under the all-solid-state battery operating environment (temperature/humidity, etc.).

For example, the second solid electrolyte may be an oxide-based solid electrolyte, and the oxide-based solid electrolyte may include Garnet-type, Nasicon-type, LISICON-type, or combinations thereof.

The Garnet-type solid electrolytes may indicate lithium-lanthanum zirconium oxide (LLZO) represented by LiₐLa_{b}Zr_{c}O₁₂ (0<a<7, 0<b<3, 0<c<2), such as Li₇La₃Zr₂O₁₂. The Nasicon-type solid electrolyte may indicate lithium-aluminum-titanium-phosphate (LATP) represented by Li₁₊ₓAlₓTi₂₋ₓ(PO₄)₃(0<x<1) in which Ti is introduced into a Li₁₊ₓAlₓM₂₋ₓ(PO₄)₃(LAMP) (0<x<2, wherein M is Zr, Ti, or Ge)-type compound, lithium-aluminum-germanium-phosphate (LAGP) represented by Li₁₊ₓAlₓGe₂₋ₓ(PO₄)₃(0<x<1), such as Li_{1.3}Al_{0.3}Ti_{1.7}(PO₄)₃ or the like in which excess lithium is introduced, and/or lithium-zirconium-phosphate (LZP) of LiZr₂(PO₄)₃.

In addition, the LISICON-type solid electrolyte may indicate a solid solution oxide represented by xLi₃AO₄-(1-x)Li₄BO₄ (A: P, As, V, etc., B: Si, Ge, Ti, etc.) and including Li₄Zn(GeO₄)₄, Li₁₀GeP₂O₁₂ (LGPO), Li_{3.5}Si_{0.5}P_{0.5}O₄, Li_{10.42}Si(Ge)_{1.5}P_{1.5}Cl_{0.08}O_{11.92}, etc., and solid solution sulfide including Li₂S—P₂S₅, Li₂S—SiS₂, Li₂S—SiS₂—P₂S₅, or Li₂S—GeS₂, etc. represented by Li₄₋ₓM_{1-y}M′_{y}S₄ (M: Si, Ge, and M′: P, Al, Zn, or Ga, 0<x<1, 0<y<1).

According to some embodiments, the second solid electrolyte may be located on the surface of the positive electrode active material, and the second solid electrolyte may be located on a part of the surface of the positive electrode active material.

For example, the second solid electrolyte may be a coating layer surrounding a part of the surface of the positive electrode active material.

For example, the second solid electrolyte may be coated to surround 5% or more of the surface area of the positive electrode active material. For example, the second solid electrolyte may be formed to surround 5% or more, 7% or more, or 10% or more of the surface area of the positive electrode active material, but are not particularly limited thereto.

For example, the second solid electrolyte may be included in an amount of 0.1 to 10 parts by weight based on 100 parts by weight of the positive electrode active material, for example, 0.1 to 8 parts by weight, 0.1 to 5 parts by weight, or 0.1 to 3 parts by weight.

If the second solid electrolyte is included in less than 0.1 parts by weight based on 100 parts by weight of the positive electrode active material, the second solid electrolyte may not be sufficiently coated on the positive electrode active material. If the second solid electrolyte is included in more than 10 parts by weight, there may be a problem that the second solid electrolyte is not coated on the surface of the positive electrode active material and agglomerated separately.

For example, the second solid electrolyte may be coated on the surface of the electrode active material with an average thickness of 1 nm to 10 nm, for example, 2 nm to 8 nm.

The average thickness of the second solid electrolyte coated on the surface of the electrode active material may be measured through TEM analysis.

First, a part of the positive electrode active material layers 121 and 122 of the all-solid-state battery 100 is sampled through ion milling, polishing, or FIB. At this time, the sampled part must contain at least one positive electrode active material particle.

The thickness may be measured through the part coated with the second solid electrolyte among the sampled positive electrode active material surfaces. At this time, elemental analysis (Energy dispersive spectroscopy (EDS)) may be used during TEM analysis to find where the second solid electrolyte is coated on the surface of the positive electrode active material. To distinguish between the positive electrode active material and the second solid electrolyte, the contrast difference in a bright field image or the contrast difference in a STEM image may be used.

The average thickness may be derived by measuring the coating thickness of the second solid electrolyte in at least 10 samples and calculating the arithmetic average value.

When the second solid electrolyte is included in the content of the positive electrode active material in the above range and coated to have a thickness in the above range, it is possible to improve the rate capability of the all-solid-state battery without interfering with densification of the electrode layer.

For example, the positive electrode active material may include a high-cobalt positive electrode active material. While high cobalt-based positive electrode active materials have the advantage of having a small volume change during charge/discharge of the all-solid-state battery, there is a problem in that the rate capability of the battery is reduced due to low ionic conductivity. Accordingly, by placing the second solid electrolyte having the above-described high ionic conductivity on the surface of the high cobalt-based positive electrode active material, it is possible to improve the density of the electrode layer and the rate capability of the battery. Therefore, the all-solid-state battery according to some embodiments of the present disclosure includes an electrode layer with improved density while reducing volume change during charge/discharge, thereby effectively improving the rate capability of the battery.

For example, the high cobalt-based positive electrode active material may be represented by Chemical Formula 1.

LiCoₓM¹_{y}M²_{1-x-y}O₂ [Chemical Formula 1]

In Chemical Formula 1, 0.6≤x≤1.0, 0≤y≤0.3,

M¹ may be Ni, Al, Mn, or combination thereof, and M² may be Mn, Na, Mg, Ti, Ni, Al, Si, Zr, Zn, Nb, Cr, Fe, Sr, V, Cu, B, Ba, Ca, Ce, Se, Sn, W, Y, or combination thereof.

For example, the high cobalt-based positive electrode active material may include at least one selected from the group consisting of LiCoO₂, LiCo_{0.98}Nb_{0.1}Al_{0.1}O₂, LiNi_{0.3}Co_{0.6}Mn_{0.1}O₂, or combination thereof.

For example, the average particle size (D50) of the high cobalt-based positive active material may be 1 μm to 10 μm.

For example, in addition to the high cobalt-based positive electrode active material described above, the positive electrode active material may further include lithium cobalt oxide, lithium nickel cobalt manganese oxide, lithium nickel cobalt aluminum oxide, lithium iron phosphate, lithium manganese oxide, or a combination thereof.

The positive electrode active material may be, for example, a compound represented by the following formula: LiₐA_{I-b}M_{b}D₂ (where 0.90≤a≤1.8, 0≤b≤0.5); LiₐE_{I-b}M_{b}O_{2-c}D_{c} (where 0.90≤a≤1.8, 0≤b≤0.5, 0≤c≤0.05); LiE_{2-b}M_{b}O_{4-c}D_{c} (where 0≤b≤0.5, 0≤c≤0.05); LiₐNi_{1-b-c}Co_{b}M_{c}D^{α} (where 0.90≤a≤1.8, 0≤b≤0.5, 0≤c≤0.05, 0≤α≤2); LiₐNi_{1-b-c}Co_{b}M_{c}O_{2-α}Xₐ (where 0.90≤a≤1.8, 0≤b≤0.5, 0≤c≤0.05, 0<a<2); LiₐNi_{1-b-c}CO_{b}M_{c}O_{2-α}X₂ (where 0.90≤a≤1.8, 0≤b≤0.5, 0≤c≤0.05, 0<α≤2); LiₐNi_{1-b-c} Mn_{b}M_{c}Dₐ (where 0.90≤a≤1.8, 0≤b≤0.5, 0≤c≤0.05, 0≤α≤2); LiₐNi_{1-b-c}Mn_{b}M_{c}O_{2-α}Xₐ (where 0.90≤a≤1.8, 0≤b≤0.5, 0≤c≤0.05, 0<a<2); LiₐNi_{1-b-c}Mn_{b}M_{c}O_{2-α}X₂ (where 0.90≤a≤1.8, 0≤b≤0.5, 0≤c≤0.05, 0<a<2); LiₐNi_{b}E_{c}G_{d}O₂ (where 0.90≤a≤1.8, 0≤b≤0.9, 0≤c≤0.5, 0.001≤d≤0.1); LiₐNi_{b}Co_{c}Mn_{d}GeO₂ (where 0.90≤a≤1.8, 0≤b≤0.9 0≤c≤0.5, 0≤d≤0.5, 0.001≤e≤0.1); LiₐNiGbO₂ (where 0.90≤a≤1.8, 0.001≤b≤0.1); LiₐCoGbO₂ (where 0.90≤a≤1.8, 0.001≤b≤0.1); LiₐMnGbO₂ (where 0.90≤a≤1.8, 0.001≤b≤0.1); LiₐMn₂GbO₄ (where 0.90≤a≤1.8, 0.001<b<0.1); QO₂; QS₂; LiQS₂; V₂O₅; LiV₂O₂; LiRO₂; LiNiVO₄; Li_{(3-f)}J₂PO₄₃ (0≤f≤2); Li_{(3-f)}Fe₂PO₄₃ (where 0≤f≤2); and LiFePO₄. In the above formula, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; and J is V, Cr, Mn, Co, Ni, or Cu.

The positive electrode active material may also be LiCoO₂, LiMnₓO₂ₓ (where x=1 or 2), LiNi₁₋ₓMnₓO₂ₓ (where 0<x<1), LiNi_{1-x-y}CoₓMn_{y}O₂ (where 0≤x≤0.5, 0≤y≤0.5), LiFePO₄, TiS₂, FeS₂, TiS₃, or FeS₃.

The solid electrolyte that may be included in the positive electrode active material layers 121 and 122 may be a solid electrolyte that may be used in the solid electrolyte layer 130 described above. The solid electrolyte may function as an ion conduction channel in the positive electrode layer 120, thereby reducing interfacial resistance.

For example, the positive electrode active material layers 121 and 122 may further include the first solid electrolyte.

The content of the first solid electrolyte is 0.1 part by weight or more, may be 1 part by weight or more, or 10 parts by weight or more, and may be 80 parts by weight or less, 60 parts by weight or less, or 50 parts by weight or less, based on 100 parts by weight of the total weight of the positive electrode active material.

The conductive material is not particularly limited as long as it has conductivity without causing a chemical change in the all-solid-state battery 100. For example, graphite, such as natural graphite or artificial graphite; a carbon-based material such as carbon black, acetylene black, Ketjen Black®, channel black, furnace black, lamp black, and summer black; a conductive fiber such as carbon fiber and metal fiber; carbon fluoride; a metal powder such as aluminum and nickel powder; a conductive whisker such as zinc oxide and potassium titanate; a conductive metal oxide such as titanium oxide; or a conductive material such as polyphenylene derivative may be used.

The content of the conductive material may be 1 to 10 parts by weight, for example, 2 to 5 parts by weight, based on 100 parts by weight of the total weight of the positive electrode active material. When the content of the conductive material is within the above range, the electrode finally obtained may have excellent conductivity characteristics.

The binder may be used to improve the bonding force between the active material and the conductive material. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, various copolymers and the like.

The content of the binder may be 0 parts by weight to 50 parts by weight, 1 part by weight to 50 parts by weight, for example, 2 parts by weight to 5 parts by weight, based on 100 parts by weight of the total weight of the positive electrode active material. When content of the binder satisfies the above range, the active material layer may have a high bonding force.

The positive electrode current collector 123 is not particularly limited as long as it has conductivity without causing chemical changes in the positive electrode or the battery.

For example, as the positive electrode current collector 123, a porous body such as a net shape or a mesh shape may be used, and a porous metal plate such as stainless steel, nickel, or aluminum may be used.

Additionally, the positive electrode current collector 123 may be coated with an oxidation-resistant metal or alloy coating to prevent oxidation.

For example, as the positive electrode current collector 123, graphite such as natural graphite or artificial graphite; carbon-based materials such as carbon black, acetylene black, Ketjen Bkack®, channel black, furnace black, lamp black, and summer black; conductive fibers such as carbon fiber, carbon nanotube (CNT), vapor grown carbon fiber (VGCF), and metal fiber may be used.

For example, the positive electrode current collector 123 may further include different types of solid electrolytes described above.

The negative electrode active material layers 141 and 142 may include a negative electrode active material and, optionally, a solid electrolyte. Additionally, the negative electrode active material layers 141 and 142 may optionally further include additives such as a binder or a conductive material.

As the negative electrode active material, a carbon-based material, silicon, silicon oxide, silicon-based alloy, a silicon-carbon-based material composite, tin, a tin-based alloy, a tin-carbon composite, a metal oxide or a combination thereof and may be used, and the negative electrode active material may include a lithium metal and/or a lithium metal alloy.

The lithium metal alloy may include lithium and a metal/metalloid capable of alloying with lithium. For example, the metal/metalloid capable of alloying with lithium may include Si, Sn, Al, Ge, Pb, Bi, Sb, Si—Y alloy (where Y is an alkali metal, alkaline earth metal, group 13 to 16 elements, transition metal, rare earth element or combinations thereof, and does not contain Si), an Sn—Y alloy (where Y is an alkali metal, alkaline earth metal, group 13 to 16 elements, transition metal, transition metal oxide of lithium titanium oxide (Li₄Ti₅O₁₂), etc., a rare earth element or combination elements thereof, and does not include Sn), MnOx (0<x≤2), etc.

The element Y may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or combinations thereof.

Further, the oxide of the metal/metalloid capable of alloying with lithium may include lithium titanium oxide, vanadium oxide, lithium vanadium oxide, SnO₂, SiOₓ (0<x<2), or the like. For example, the negative electrode active material may include one or more elements selected from the group consisting of group 13 to 16 elements of the Periodic Table of Elements. For example, the negative electrode active material may include one or more elements selected from the group consisting of Si, Ge, and Sn.

The carbon-based material may be crystalline carbon, amorphous carbon, or a mixture thereof. The crystalline carbon may include graphite such as amorphous, plate-like, flake-like, spherical or fibrous natural graphite or artificial graphite. In addition, amorphous carbon may include soft carbon (low temperature fired carbon) or hard carbon, mesophase pitch carbide, fired coke, graphene, carbon black, fullerene soot, carbon nanotubes, carbon fiber, or the like.

The silicon may be selected form the group consisting of Si, SiOₓ (0<x<2, for example 0.5 to 1.5), Sn, SnO₂, or a silicon-containing metal alloy and mixtures thereof. The silicon-containing metal alloy may include, for example, silicon and at least one of Al, Sn, Ag, Fe, Bi, Mg, Zn, in, Ge, Pb, and Ti.

The solid electrolyte that may be used in the solid electrolyte layer 130 described above. The solid electrolyte may function as an ion conduction channel in the negative electrode layer 140, thereby reducing interfacial resistance.

For example, the negative electrode active material layers 141 and 142 may further include the first solid electrolyte.

The content of the first solid electrolyte is 0.1 part by weight or more, may be 1 part by weight or more, or 10 parts by weight or more, and may be 80 parts by weight or less, 60 parts by weight or less, or 50 parts by weight or less, based on 100 parts by weight of the total weight of the positive electrode active material.

The negative electrode active material layers 141 and 142 may also optionally include a conductive material and a binder as described for the positive electrode active material layers 121 and 122.

The negative electrode current collector 143 is not particularly limited as long as it has conductivity without causing chemical changes in the positive electrode or the battery.

For example, as the negative electrode current collector 143, a porous body such as a net shape or a mesh shape may be used, and a porous metal plate such as stainless steel, nickel, or aluminum may be used.

Additionally, the negative electrode current collector 143 may be coated with an oxidation-resistant metal or alloy coating to prevent oxidation.

For example, as the negative electrode current collector 143, graphite such as natural graphite or artificial graphite; carbon-based materials such as carbon black, acetylene black, ketjen black, channel black, furnace black, lamp black, and summer black; conductive fibers such as carbon fiber, carbon nanotube (CNT), vapor grown carbon fiber (VGCF), and metal fiber may be used.

For example, the negative electrode current collector 143 may further include one or more types of solid electrolytes described above.

If the negative electrode active material layers 141 and 142 have excellent conductivity, the negative electrode current collector 143 may be excluded from the negative electrode layer 140.

Referring to FIG. 2, the all-solid-state battery 100 according to some embodiments may further include a margin layer 150 disposed along the edge of the positive electrode layer 120 and the negative electrode layer 140.

Referring to FIG. 2, the margin layer 150 is located on the solid electrolyte layer 130 and may be disposed at a lateral edge of the positive electrode active material layers 121 and 122 or the negative electrode active material layers 141 and 142. Accordingly, the margin layer 150 may be located in the same layer of the positive electrode layer 120 and the negative electrode layer 140, respectively.

The margin layer 150 may include an insulating material having an ionic conductivity of 1.0×10⁻¹⁰ S/cm or less, or 1.0×10⁻⁶ S/cm or less, and may be used without limitation on the type as long as it is commonly used.

For example, the insulating material may include an insulating material such as ceramic or resin.

The ceramics may include aluminum nitride (AlN), beryllium oxide (BeO), boron nitride (BN), silicon (Si), silicon carbide (SiC), silicon nitride (Si₃N₄), gallium arsenide (GaAs), gallium nitride (GaN), barium titanate (BaTiO₃), mixtures thereof, or oxides and/or nitrides of these materials.

For example, the resin may include polyolefin such as polyethylene or polypropylene, polyester such as polyethylene terephthalate (PET), polyurethane, or polyimide.

Additionally, the margin layer 150 may further include the solid electrolyte included in the solid electrolyte layer 130 described above.

The all-solid-state battery 100 according to some embodiments may further include a cover layer (not shown) located on one or both sides in the stacking direction of the cell stack. For example, the cover layer may be located on the outermost side in the stacking direction of the cell stack of the all-solid-state battery 100. The cover layer may be located on the outside of the cell stack, thereby relieving the impact of the all-solid-state battery, preventing infiltration into the interior, and preventing current leakage.

For example, the cover layer may surround the surface of the cell stack so that one end of the positive electrode layer 120 is exposed to the first surface and connected to one external electrode 112, and one end of the negative electrode layer 140 is exposed to the second surface and connected to another external electrode 114. For example, the cover layer may be located on the third and fourth surfaces excluding the first and second surfaces of the cell stack, or may be placed on the outer surface of the positive electrode layer 120 located at the bottom and the negative electrode layer 140 located at the top in the stacking direction of the cell stack.

At this time, the solid electrolyte layer 130 may be disposed between the cover layer and the positive electrode layer 120 or negative electrode layer 140 adjacent thereto.

The cover layer may include an insulating material having an ionic conductivity of 1.0×10⁻¹⁰ S/cm or less, or 1.0×10⁻⁶ S/cm or less, for the purpose of providing insulating properties, and may be used without limitation on the type as long as it is commonly used.

For example, the insulating material may include an insulating material such as ceramic or resin, and since this is the same as the insulating material included in the margin layer, detailed description will be omitted.

The terminals of the positive electrode current collector 123 and the terminals of the negative electrode current collector 143 are exposed on both sides of the cell stack of the all-solid-state battery 100, and external electrodes 112 and 114 may be connected and combined to these exposed terminals. That is, the external electrodes 112 and 114 may be configured to be connected to the terminal of the positive electrode current collector 123 to have a positive electrode, and to be connected to the terminal of the negative electrode current collector 143 to have a negative electrode. If the terminals of the positive electrode current collector 123 and the terminals of the negative electrode current collector 143 are configured to face opposite directions, the external electrodes 112 and 114 may also be located on both sides, respectively.

The external electrodes 112 and 114 may cover not only the cell stack but also the sides of the cover layer. That is, the cover layer is manufactured by firing together through batch firing during the cell stack manufacturing, and as the external electrodes 112 and 114 are formed, the external electrodes 112 and 114 may also be located on the sides of the cover layer.

The external electrodes 112 and 114 may include a conductive metal and glass.

The conductive metal may include at least one selected from the group consisting of, for example, copper (Cu), nickel (Ni), tin (Sn), palladium (Pd), platinum (Pt), gold (Au), silver (Ag), tungsten (W), titanium (Ti), lead (Pb) and alloys thereof.

The glass component included in the external electrodes 112 and 114 may be a composition in which oxides are mixed. The glass component may include at least one selected from the group consisting of, for example, silicon oxide, boron oxide, aluminum oxide, transition metal oxide, alkali metal oxide, and alkaline earth metal oxide, and combinations thereof. Here, the transition metal is selected from zinc (Zn), titanium (Ti), copper (Cu), vanadium (V), manganese (Mn), iron (Fe), or nickel (Ni), and the alkali metal is selected from lithium (Li), sodium (Na), or potassium (K), and the alkaline earth metal may be selected from magnesium (Mg), calcium (Ca), strontium (Sr), or barium (Ba).

The method of forming the external electrodes 112 and 114 is not particularly limited. For example, the external electrodes may be formed by dipping the cell stack in a conductive paste containing a conductive metal and glass, or may be formed by printing the conductive paste on a surface of the cell stack by a screen printing method or gravure printing method. In addition, various methods may be used, such as applying the conductive paste to the surface of the cell stack or transferring a dry film obtained by drying the conductive paste on the cell stack.

A stacked all-solid-state battery according to some embodiments includes a plurality of solid electrolyte layers, a plurality of positive electrode layers and a negative electrode layer alternately disposed with the plurality of solid electrolyte layers interposed. The solid electrolyte layers include a first solid electrolyte layer, the positive electrode layers or the negative electrode layers include an electrode active material and a second solid electrolyte located on the surface of the electrode active material, and the lithium ion conductivity (25° C.) of the second solid electrolyte is 1.0×10² times or more than the lithium ion conductivity (25° C.) of the first solid electrolyte.

Hereinafter, specific Examples of the present disclosure are provided. However, the Examples described below are only intended to specifically illustrate or explain the present disclosure, and the range of the present disclosure should not be limited thereto.

### EXAMPLE

### Comparative Example 1-1

A positive electrode layer green sheet was manufactured by mixing LiCoO₂ as the positive electrode active material, Li₂O—B₂O₃—SiO₂ (hereinafter referred to as “LBSO”) as the solid electrolyte, and carbon black as the conductive material in a volume ratio of 47.5:47.5:5, printing the positive active material layer using a screen printer, mixing graphite and LBSO in a volume ratio of 5:5, and then printing the current collection layer using a screen printer.

A negative electrode layer green sheet was manufactured by mixing 2 μm graphite as a negative electrode active material and LBSO as a solid electrolyte were mixed in a 5:5 volume ratio, and using a screen printer.

A solid electrolyte layer green sheet was manufactured including LBSO (lithium ion conductivity: 5.0×10⁻⁷ S/cm) as the first solid electrolyte.

An all-solid-state battery cell was manufactured by stacking the prepared positive electrode layer green sheet, negative electrode layer green sheet, and solid electrolyte layer green sheet, and then pressure firing.

### Example 1-1

An all-solid-state-battery cell was manufactured in the same manner as in Comparative Example 1-1, except that the second solid electrolyte, Li_{1.3} Al_{0.3}Ti_{1.7}(PO₄)₃ (hereinafter, referred to as “LATP”, lithium ion conductivity: 1.0×10⁻⁴ S/cm), was included in an amount of 1.5 parts by weight based on 100 parts by weight of LiCoO₂, which is a positive electrode active material, and the second solid electrolyte was coated on the positive electrode active material to a thickness of 6.7 nm.

### Example 1-2

An all-solid-state-battery cell was manufactured in the same manner as in Example 1-1, except that the second solid electrolyte, LATP, was included in an amount of 3.0 parts by weight based on 100 parts by weight of LiCoO₂, which was a positive electrode active material, and the second solid electrolyte was coated on the positive electrode active material to a thickness of 6.8 nm.

### Comparative Example 1-2

An all-solid-state-battery cell was manufactured in the same manner as in Example 1-1, except that the second solid electrolyte, LATP, was included in an amount of 6.0 parts by weight based on 100 parts by weight of LiCoO₂, which was a positive electrode active material, and the second solid electrolyte is coated on the positive electrode active material to a thickness of 11.6 nm.

Referring to Table 1, it can be seen that in the case of Comparative Example 1-2, the second solid electrolyte was not coated on the positive electrode active material but was agglomerated separately, making it difficult to measure the coated area.

### Comparative Example 2-1

A positive electrode layer green sheet was manufactured by mixing LiCo_{0.98}Nb_{0.1}Al_{0.1}O₂ as the positive electrode active material, Li₂O—B₂O₃—SiO₂ (hereinafter referred to as “LBSO”) as the solid electrolyte, and carbon black as the conductive material in a volume ratio of 47.5:47.5:5, printing the positive active material layer using a screen printer, mixing graphite and LBSO in a volume ratio of 5:5, and then printing the current collection layer using a screen printer.

A negative electrode layer green sheet was manufactured by mixing 2 μm graphite as a negative electrode active material and LBSO as a solid electrolyte are mixed in a 5:5 volume ratio, and using a screen printer.

A solid electrolyte layer green sheet was manufactured including LBSO as the first solid electrolyte.

An all-solid-state battery cell was manufactured by stacking the prepared positive electrode layer green sheet, negative electrode layer green sheet, and solid electrolyte layer green sheet, and then pressure firing.

### Example 2-1

An all-solid-state-battery cell was manufactured in the same manner as in Comparative Example 2-1, except that the second solid electrolyte, LATP, was included in an amount of 0.2 parts by weight based on 100 parts by weight of LiCo_{0.98}Nb_{0.1}Al_{0.1}O₂, which was a positive electrode active material, and the second solid electrolyte was coated on the positive electrode active material to a thickness of 4.5 nm.

### Example 2-2

An all-solid-state-battery cell was manufactured in the same manner as in Example 2-1, except that the second solid electrolyte, LATP, was included in an amount of 1.5 parts by weight based on 100 parts by weight of LiCo_{0.98}Nb_{0.1}Al_{0.1}O₂, which was a positive electrode active material, and the second solid electrolyte is coated on the positive electrode active material to a thickness of 6.5 nm.

### Example 2-3

An all-solid-state-battery cell was manufactured in the same manner as in Example 2-1, except that the second solid electrolyte, LATP, was included in an amount of 3.0 parts by weight based on 100 parts by weight of LiCo_{0.98}Nb_{0.1}Al_{0.1}O₂, which was a positive electrode active material, and the second solid electrolyte is coated on the positive electrode active material to a thickness of 7.2 nm.

### Comparative Example 2-2

An all-solid-state-battery cell was manufactured in the same manner as in Example 2-1, except that the second solid electrolyte, LATP, is included in an amount of 5.0 parts by weight based on 100 parts by weight of LiCo_{0.98}Nb_{0.1}Al_{0.1}O₂, which is a positive electrode active material, and the second solid electrolyte is coated on the positive electrode active material to a thickness of 10.8 nm.

### Comparative Example 3-1

A positive electrode layer green sheet was manufactured by mixing LiNi_{0.3}Co_{0.6}Mn_{0.1}O₂ as the positive electrode active material, Li₂O—B₂O₃—SiO₂ (hereinafter referred to as “LBSO”) as the solid electrolyte, and carbon black as the conductive material in a volume ratio of 47.5:47.5:5, printing the positive active material layer using a screen printer, mixing graphite and LBSO in a volume ratio of 5:5, and then printing the current collection layer using a screen printer. A negative electrode layer green sheet was manufactured by mixing 2 μm graphite as a negative electrode active material and LBSO as a solid electrolyte are mixed in a 5:5 volume ratio, and using a screen printer.

A solid electrolyte layer green sheet was manufactured including LBSO as the first solid electrolyte.

An all-solid-state battery cell was manufactured by stacking the prepared positive electrode layer green sheet, negative electrode layer green sheet, and solid electrolyte layer green sheet, and then pressure firing.

### Example 3-1

An all-solid-state-battery cell was manufactured in the same manner as in Comparative Example 3-1, except that the second solid electrolyte, LATP, was included in an amount of 0.2 parts by weight based on 100 parts by weight of LiNi_{0.3}Co_{0.6}Mn_{0.1}O₂, which was a positive electrode active material, and the second solid electrolyte was coated on the positive electrode active material to a thickness of 2.5 nm.

### Example 3-2

An all-solid-state-battery cell was manufactured in the same manner as in Example 3-1, except that the second solid electrolyte, LATP, was included in an amount of 0.8 parts by weight based on 100 parts by weight of LiNi_{0.3}Co_{0.6}Mn_{0.1}O₂, which was a positive electrode active material, and the second solid electrolyte was coated on the positive electrode active material to a thickness of 4.8 nm.

### Example 3-3

An all-solid-state-battery cell was manufactured in the same manner as in Example 3-1, except that the second solid electrolyte, LATP, was included in an amount of 3.0 parts by weight based on 100 parts by weight of LiNi_{0.3}Co_{0.6}Mn_{0.1}O₂, which was a positive electrode active material, and the second solid electrolyte was coated on the positive electrode active material to a thickness of 6.5 nm.

### Comparative Example 3-2

An all-solid-state-battery cell was manufactured in the same manner as in Example 3-1, except that the second solid electrolyte, LATP, was included in an amount of 5.0 parts by weight based on 100 parts by weight of LiNi_{0.3}Co_{0.6}Mn_{0.1}O₂, which was a positive electrode active material, and the second solid electrolyte was coated on the positive electrode active material to a thickness of 10.2 nm.

### Evaluation Example

### Evaluation Example 1: Analysis of Positive Electrode Layer Density

The positive electrode layer density of the all-solid-state batteries according to Examples 1-1 to 3-3 and Comparative Examples 1-1 to 3-2 was analyzed and shown in Tables 1 to 3 below.

The density of the positive electrode layer of an all-solid-state battery was measured through SEM analysis. Specifically, a cross-sectional sample of the positive electrode layer of an all-solid-state battery is obtained through ion milling or polishing, and then the SEM image of the cross-sectional sample was analyzed. Referring to FIG. 3, it can be seen that pores exist between the positive electrode active material, the first solid electrolyte, and the conductive material in the SEM image of the positive electrode layer, and the pores were distinguished by contrast differences during SEM-BSE mode analysis. The area of pores compared to the entire area of the positive electrode layer was represented by a percentage, and the lower the value, the denser the positive electrode layer is considered to be.

Based on Comparative Example 1-1, Comparative Example 2-1, and Comparative Example 3-1 shown in Tables 1 to 3 below, if the above-mentioned % value decreases by less than 3, it is determined to be ‘slightly improved’, and if it decreases by 3 or more, it is determined to be ‘improved’.

### Evaluation Example 2: Analysis of Rate Capability of all-Solid-State Battery

The rate capabilities of the all-solid-state batteries according to Examples 1-1 to 3-3 and Comparative Examples 1-1 to 3-2 were analyzed and are shown in Tables 1 to 3 below.

The rate capability of an all-solid-state battery was measured by changing the charge/discharge current of the all-solid-state battery. First, connect the external electrode of the all-solid-state battery to the battery charger/discharger. The all-solid-state battery is charged and discharged twice at 0.05 C-rate using a battery charger/discharger, and then charged and discharged once at 0.5 C-rate. At this time, the discharge capacity value during the 0.5 C-rate charge/discharge compared to the second discharge capacity among the results of charge/discharge at a 0.05 C-rate was represented by a capacity ratio (%). It was determined that the higher the capacity ratio (%), the better the rate capability were improved.

Based on Comparative Example 1-1, Comparative Example 2-1, and Comparative Example 3-1 shown in Tables 1 to 3 below, if the above-mentioned % value decreases by less than 5, it is determined to be ‘slightly improved’, and if it decreases by 5 or more, it is determined to be ‘improved’.

TABLE 1

| | Type of | Content of | Thickness of | | | |
|---|---|---|---|---|---|---|
| | positive | second solid | second solid | | Positive | |
| | electrode | electrolyte | electrolyte | Coated | electrode | |
| | active | (parts by | coating | area | layer | Rate |
| | material | weight) | (nm) | (%) | density | capability |
| Comparative | LiCoO₂ | 0 | 0 | 0 | Reference | Reference |
| Example 1-1 | | | | | | |
| Example 1-1 | | 1.5 | 6.7 | 10% | Slightly | Slightly |
| | | | | | improved | improved |
| Example 1-2 | | 3.0 | 6.8 | 50% | Improved | Improved |
| Comparative | | 6.0 | 11.6 | — | Improved | Deteriorated |
| Example 1-2 | | | | | | |

(In Table 1 above, ‘—’ refers to the case where the second solid electrolyte is not coated on the positive electrode active material but is agglomerated separately.)

Referring to Table 1, in the case of using LiCoO₂ as the type of positive electrode active material, it can be seen that the all-solid-state battery cells of Comparative Example 1-1 in which the second solid electrolyte was not coated on the positive electrode active material, and Comparative Example 1-2 in which the second solid electrolyte was excessively added and coated thicker than 10 nm on the positive electrode active material, had a low positive electrode layer density, and the rate capabilities of the battery were deteriorated.

Referring to Table 1, it can be seen that in Examples 1-1 and 1-2, both positive electrode layer density and rate capability were improved compared to Comparative Example 1-1.

TABLE 2

| | | Content | Thickness | | | |
|---|---|---|---|---|---|---|
| | | of second | of second | | | |
| | | solid | solid | | Positive | |
| | Type of positive | electrolyte | electrolyte | Coated | electrode | |
| | electrode active | (parts by | coating | area | layer | Rate |
| | material | weight) | (nm) | (%) | density | capability |
| Comparative | LiCo_{0.98}Nb_{0.1}Al_{0.1}O₂ | 0 | 0 | 0 | Reference | Reference |
| Example 2-1 | | | | | | |
| Example 2-1 | | 0.2 | 4.5 | 10% | Slightly | Slightly |
| | | | | | improved | improved |
| Example 2-2 | | 1.5 | 6.5 | 50% | Slightly | Improved |
| | | | | | improved | |
| Example 2-3 | | 3.0 | 7.2 | 50% | Improved | Improved |
| Comparative | | 5.0 | 10.8 | 50% | Improved | Deteriorated |
| Example 2-2 | | | | | | |

Referring to Table 2, in the case of using LiCo_{0.98}Nb_{0.1}Al_{0.1}O₂ as the type of positive electrode active material, it can be seen that the all-solid-state battery cells of Comparative Example 2-1 in which the second solid electrolyte was not coated on the positive electrode active material, and Comparative Example 2-2 in which the second solid electrolyte was excessively added and coated thicker than 10 nm on the positive electrode active material, have a low positive electrode layer density, and the rate capabilities of the battery were deteriorated.

Referring to Table 2, it can be seen that in Examples 2-1 to 2-3, both positive electrode layer density and rate capability were improved compared to Comparative Example 2-1.

TABLE 3

| | | Content of | Thickness | | | |
|---|---|---|---|---|---|---|
| | | second | of second | | | |
| | | solid | solid | | Positive | |
| | Type of positive | electrolyte | electrolyte | Coated | electrode | |
| | electrode active | (parts by | coating | area | layer | Rate |
| | material | weight) | (nm) | (%) | density | capability |
| Comparative | LiNi_{0.3}Co_{0.6}Mn_{0.1}O₂ | 0 | 0 | 0 | Reference | Reference |
| Example 3-1 | | | | | | |
| Example 3-1 | | 0.2 | 2.5 | 10% | Slightly | Slightly |
| | | | | | improved | improved |
| Example 3-2 | | 0.8 | 4.8 | 50% | Improved | Slightly |
| | | | | | | improved |
| Example 3-3 | | 3.0 | 6.5 | 50% | Improved | Improved |
| Comparative | | 5.0 | 10.2 | 50% | Improved | Deteriorated |
| Example 3-2 | | | | | | |

Referring to Table 3, in the case of using LiNi_{0.3}Co_{0.06}Mn_{0.1}O₂ as the type of positive electrode active material, it can be seen that the all-solid-state battery cells of Comparative Example 3-1 in which the second solid electrolyte was not coated on the positive electrode active material, and Comparative Example 3-2 in which the second solid electrolyte was excessively added and coated thicker than 10 nm on the positive electrode active material, had a low positive electrode layer density, and the rate capabilities of the battery were deteriorated.

Referring to Table 3, it can be seen that in Examples 3-1 to 3-3, both positive electrode layer density and rate capability were improved compared to Comparative Example 3-1.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: All-solid-state battery
112, 114: External electrode
120: Positive electrode layer
121, 122: Positive active material layer
123: Positive electrode current collector
130: Solid electrolyte layer
140: Negative electrode layer
141, 142: Negative active material layer
143: Negative electrode current collector
150: Margin layer

### INDUSTRIAL APPLICABILITY

The present disclosure relates to an all-solid-state battery has an advantage of improving the rate capability of the battery by densifying the electrode layer while improving interfacial bonding between materials, and thus applicable to various electrochemical devices and electronic devices.

1. An all-solid-state battery, comprising:
a solid electrolyte layer; and a positive electrode layer and a negative electrode layer disposed with the solid electrolyte layer interposed therebetween,
wherein the solid electrolyte layer includes a first solid electrolyte,
the positive electrode layer or the negative electrode layer includes an electrode active material and a second solid electrolyte surrounding a part of a surface of the electrode active material,
the second solid electrolyte has an average thickness of 1 nm to 10 nm,
the electrode active material includes a positive electrode active material,
the positive electrode active material includes a high cobalt-based positive electrode active material represented by Chemical Formula 1:
LiCoₓM¹_{y}M²_{1-x-y}O₂ [Chemical Formula 1]
in Chemical Formula 1, 0.6≤x≤1.0, 0≤y≤0.3,
M¹ is Ni, Al, Mn, or a combination thereof, and M² is at least one selected from the group consisting of Mn, Na, Mg, Ti, Ni, Al, Si, Zr, Zn, Nb, Cr, Fe, Sr, V, Cu, B, Ba, Ca, Ce, Se, Sn, W, Y, and combinations thereof.

2. The all-solid-state battery of claim 1, wherein:
a lithium ion conductivity (25° C.) of the second solid electrolyte is 1.0×10² times or more than a lithium ion conductivity (25° C.) of the first solid electrolyte.

3. The all-solid-state battery of claim 1, wherein:
a lithium ion conductivity (25° C.) of the first solid electrolyte is 1.0×10⁻⁷ S/cm to 1.0×10⁻⁶ S/cm.

4. The all-solid-state battery of claim 1, wherein:
a lithium ion conductivity (25° C.) of the second solid electrolyte is 1.0×10⁻⁴ S/cm to 1.0×10⁻³ S/cm.

5. The all-solid-state battery of claim 1, wherein:
the first solid electrolyte includes a glass-ceramic-based electrolyte including at least one selected from the group consisting of lithium (Li) oxide, boron (B) oxide, silicon (Si) oxide, phosphorus (P) oxide, germanium (Ge) oxide, and lithium chloride (LiCl), or a lithium borosilicate-based electrolyte including at least one selected from the group consisting of lithium (Li) oxide, silicon (Si) oxide, and boron (B) oxide.

6. The all-solid-state battery of claim 1, wherein:
the second solid electrolyte includes a Garnet-type solid electrolyte, a Nasicon-type solid electrolyte, a LISICON-type solid electrolyte, or a combination thereof.

7. The all-solid-state battery of claim 6, wherein:
the Garnet-type solid electrolyte includes a lithium lanthanum zirconium oxide.

8. The all-solid-state battery of claim 6, wherein:
the Nasicon-type solid electrolyte includes lithium-aluminum-titanium-phosphate represented by Li₁₊ₓAlₓTi₂₋ₓ(PO₄)₃ (0<x<1), or lithium-aluminum-germanium-phosphate represented by Li₁₊ₓAlₓGe₂₋ₓ(PO₄)₃ (0<x<1).

9. The all-solid-state battery of claim 1, wherein:
the second solid electrolyte is included in an amount of 0.1 to 10 parts by weight based on 100 parts by weight of the electrode active material.

10. The all-solid-state battery of claim 1, wherein:
the second solid electrolyte surrounds 5% or more of a surface area of the electrode active material.

11. The all-solid-state battery of claim 1, wherein:
the positive electrode layer or the negative electrode layer further includes the first solid electrolyte.

12. An all-solid-state battery, comprising:
a solid electrolyte layer; and a positive electrode layer and a negative electrode layer disposed with the solid electrolyte layer interposed therebetween,
wherein the solid electrolyte layer includes a first solid electrolyte,
the positive electrode layer or the negative electrode layer includes an electrode active material and a second solid electrolyte surrounding a part of a surface of the electrode active material,
the second solid electrolyte has an average thickness of 1 nm to 10 nm,
a lithium ion conductivity (25° C.) of the second solid electrolyte is 1.0×10² times or more than a lithium ion conductivity (25° C.) of the first solid electrolyte,
the electrode active material includes a positive electrode active material,
the positive electrode active material includes a high cobalt-based positive electrode active material represented by Chemical Formula 1:
LiCoₓM¹_{y}M²_{1-x-y}O₂ [Chemical Formula 1]
in Chemical Formula 1, 0.6≤x≤1.0, 0≤y≤0.3,
M¹ is Ni, Al, Mn, or a combination thereof, and M² is selected from the group consisting of Mn, Na, Mg, Ti, Ni, Al, Si, Zr, Zn, Nb, Cr, Fe, Sr, V, Cu, B, Ba, Ca, Ce, Se, Sn, W, Y, and combinations thereof.

13. The all-solid-state battery of claim 12, wherein:
the lithium ion conductivity (25° C.) of the first solid electrolyte is 1.0×10⁻⁷ S/cm to 1.0×10−⁶ S/cm.

14. The all-solid-state battery of claim 12, wherein:
the lithium ion conductivity (25° C.) of the second solid electrolyte is 1.0×10⁻⁴ S/cm to 1.0×10⁻³ S/cm.

15. The all-solid-state battery of claim 12, wherein:
the first solid electrolyte includes at least one selected from the group consisting of a glass-ceramic-based electrolyte including lithium (Li) oxide, boron (B) oxide, silicon (Si) oxide, phosphorus (P) oxide, germanium (Ge) oxide, and lithium chloride (LiCl), or a lithium borosilicate-based electrolyte including at least one selected from the group consisting of lithium (Li) oxide, silicon (Si) oxide, and boron (B) oxide.

16. The all-solid-state battery of claim 12, wherein:
the second solid electrolyte includes a Garnet-type solid electrolyte, a Nasicon-type solid electrolyte, a LISICON-type solid electrolyte, or a combination thereof.

17. The all-solid-state battery of claim 16, wherein:
the Garnet-type solid electrolyte includes a lithium lanthanum zirconium oxide.

18. The all-solid-state battery of claim 16, wherein:
the Nasicon-type solid electrolyte includes lithium-aluminum-titanium-phosphate represented by Li₁₊ₓAlₓTi₂₋ₓ PO₄₃ (0<x<1), or lithium-aluminum-germanium-phosphate represented by Li₁₊ₓAlₓGe₂₋ₓ PO₄₃ (0<x<1).

19. The all-solid-state battery of claim 12, wherein:
the second solid electrolyte is included in an amount of 0.1 to 10 parts by weight based on 100 parts by weight of the electrode active material.

20. The all-solid-state battery of claim 12, wherein:
the second solid electrolyte surrounds 5% or more of a surface area of the electrode active material.

21. The all-solid-state battery of claim 12, wherein:
the positive electrode layer or the negative electrode layer further includes the first solid electrolyte.
